(19) United States
(12) Patent Application Publication
(10) Pub. No.: US 2018/0291519 A1
(43) Pub. Date: Oct. 11, 2018

(54) MANUFACTURING METHOD OF A TOOL SURFACE MARK AND PRODUCT MADE BY THE SAME

(71) Applicant: CHIEH-WEN LIU, TAICHUNG CITY (TW)

(72) Inventor: CHIEH-WEN LIU, TAICHUNG CITY (TW)

(21) Appl. No.: 15/484,334

(22) Filed: Apr. 11, 2017

(51) Int. Cl. C25D 5/48; C25D 3/12; C25D 3/04; C25D 5/14; B41M 1/26; B41M 5/00; B05D 1/02; B05D 3/02; B25B 13/06; G09F 23/00

(52) U.S. Cl. CPC C25D 5/48; C25D 3/12; C25D 3/04; C25D 5/14; G09F 23/00; B41M 5/0041; B05D 1/02; B05D 3/0254; B25B 13/06; B41M 1/26

(57) ABSTRACT

A manufacturing method of a tool surface mark includes a first cleaning step, a first electroplating step, an ionized water cleaning step, a drying step, a printing step, a second cleaning step and a second electroplating step. In the first electroplating step, the surface of the tool is electroplated to form a first protective layer on the surface of the tool. In the ionized water cleaning step, ionized water is sprayed on the surface of the tool and the ions in the ionic water are adhered to the pores of the first protective layer to form an ion-protective coating. In the second electroplating step, the surface of the tool is electroplated with nickel so that a second protective layer is formed on the surface of the tool. The ion-protective coating can enhance the adhesion of the printing pattern and make it difficult for the printing pattern to fall off.

### BACKGROUND OF THE INVENTION

### 1. Field of the Invention

The present invention relates to a manufacturing method of a surface mark, especially to a manufacturing method of a tool surface mark and the product made by the same.

### 2. Description of Related Art

Metal hand tools such as sleeves, screwdrivers or wenches, in order to apply to bolts or nuts of different sizes, would be designed in different sizes. In addition, to prevent a user from getting confused with similar metal tools of different sizes, an outer surface of the metal hand tool is marked to ensure that the user will not be confused when retrieving the metal hand tool.

TW invention patent No. I323689, entitled “Metal hand tool and manufacturing method thereof” mainly discloses printing directly on the surface of a finished product to form a printing layer on the surface of the product. An electroplated layer is formed on the area of the product other than the printing layer. However, in the above-mentioned conventional marking method, the electroplated layer is formed after the printing layer is formed, and the printing layer is easily spotted due to the electroplated layer. This may result in a low yield of printing patterns and the surface of the hand tool easily peels off, causing the difficulty of recognizing the hand tool.

To overcome the shortcomings of the conventional metal hand tool and manufacturing method thereof, the present invention provides a manufacturing method of a tool surface mark and the product thereof to mitigate or obviate the aforementioned problems.

### SUMMARY OF THE INVENTION

The main objective of the present invention is to provide a manufacturing method of a surface mark. The manufacturing method has a first cleaning step, a first electroplating step, an ionized water cleaning step, a drying step, a printing step, a second cleaning step and a second electroplating step. In the first electroplating step, the surface of the tool is electroplated to form a first protective later on the surface of the tool. In the ionized water cleaning step, the ionized water is sprayed on the surface of the tool and ions in the ionic water are adhered to the pores of the first protective layer to form an ion-protective coating. In the second electroplating step, the surface of the tool is electroplated with nickel so that a second protective layer is formed on the outer surface of the tool. The ion-protective coating can increase the adhesion of the printing pattern and make it difficult for the printing pattern to fall off.

Other objects, advantages, and novel features of the invention will become more apparent from the following detailed description when taken in conjunction with the accompanying drawing.

### BRIEF DESCRIPTION OF THE DRAWINGS

FIG. 1 is a block diagram of a manufacturing method of a tool surface mark in accordance with the present invention;

FIG. 2 is a cross sectional side view of a preferred embodiment of a hand tool made by the method in FIG. 1; and

FIG. 3 is a perspective view of the preferred embodiment of the hand tool in FIG. 2.

### DETAILED DESCRIPTION OF PREFERRED EMBODIMENT

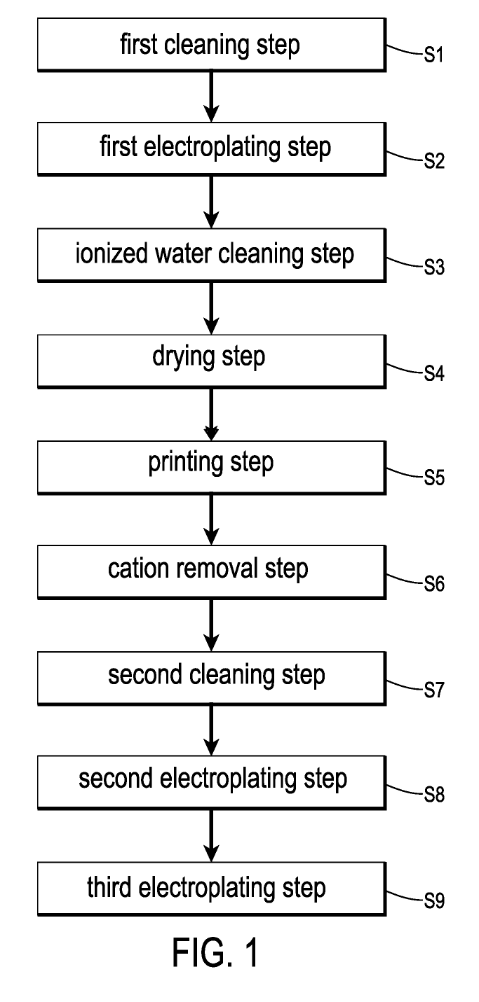

With reference to FIG. 1, a manufacturing method of a tool surface mark in accordance with the present invention comprises the following steps: a first cleaning step S1, a first electroplating step S2, an ionized water cleaning step S3, a drying step S4, a printing step S5, a cation removal step S6, a second cleaning step S7, a second electroplating step S8, and a third electroplating step S9.

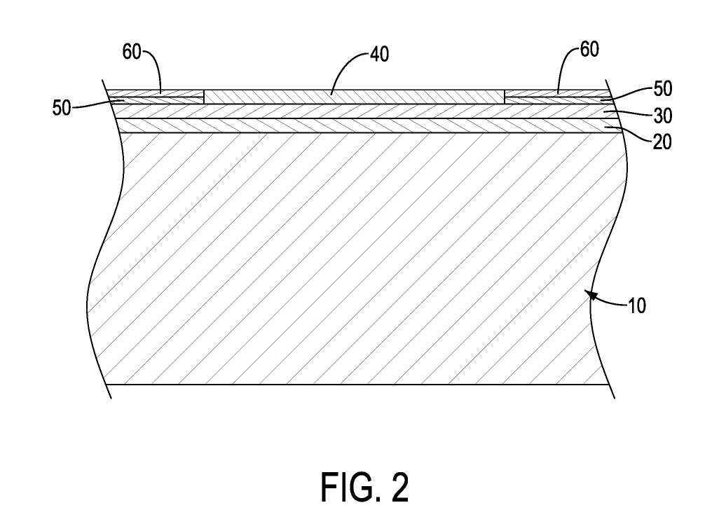

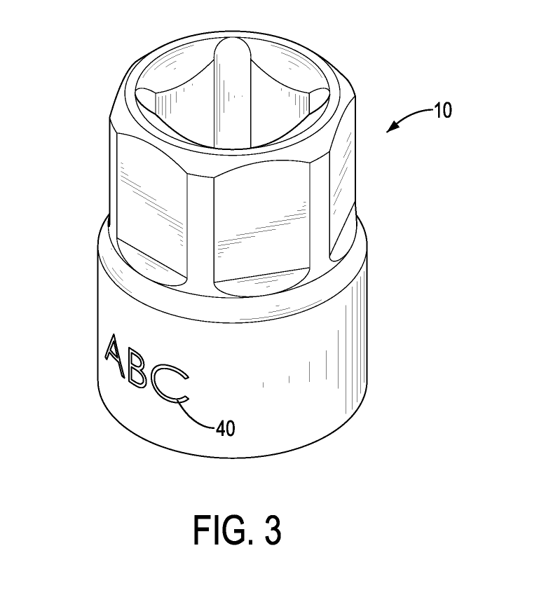

With reference to FIGS. 1 to 3, in the first cleaning step S1, a surface of a tool 10 is cleaned by clear water to remove impurities, such as dusts.

In the first electroplating step S2, the surface of the tool 10 is electroplated with nickel so that the surface of the tool 10 forms a first protective layer 20.

In the ionized water cleaning step S3, the ionized water produced by the water ionizer is sprayed on the surface of the tool 10 to clean the sulfide on the surface of the tool 10 and ions in the ionized water are adhered to the pores of the first protective layer 20 to form an ion-protective coating 30.

In the drying step S4, ionized water on the surface of the tool 10 is dried so that the ion-protective coating 30 is hardened.

In the printing step S5, a printing pattern 40 is printed on the ion-protective coating 30. Since the printing pattern 40 is attached on the ion-protective coating 30, the printing adhesion of the printing pattern 40 is enhanced, and the printing pattern 40 does not easily peel off.

In the cation removal step S6, the surface of the tool 10 is cleaned by a cation removal method. The cation removal method comprises placing the tool 10 into an electrolyte, then electrically connecting the tool 10 to an anode, and electrically energizing the anode. Metal cations on the surface of the tool 10 and on the printing pattern 40 are dissolved. The cations are attracted by anions in the electrolyte, and the metal cations in the surface of the tool 10 and the printing pattern 40 are moved into the electrolyte, whereby the cations on the surface of the tool 10 and the printing pattern 40 are removed.

In the second cleaning step S7, the printing pattern 40 is cleaned by clear water, and this reduces the acidity of the printing pattern 40, and the stains around the printing pattern 40 are cleaned.

In the second electroplating step S8, the surface of the tool 10 at portions without the printing pattern 40 thereon is electroplated with nickel so that a second protective layer 50 is formed on the surface of the tool 10 at portions without the printing pattern 40 thereon. With the aforementioned cation removal step S6, the printing pattern 40 has no residual cation on the printing pattern 40. The anions on the printing pattern 40 also leave the surface of the printing pattern 40 due to the electroplating principle during the second electroplating step S8, so that the surface of the printing pattern 40 is free of ions. Thus, no plating impurities are generated on the printing pattern 40, and the yield of the printing pattern 40 is increased and the printing pattern 40 does not easily peel off.

In the third electroplating step S9, a layer of chromium is electroplated on an outer surface of the second protective layer 50 to form a third protective layer 60 on the outer surface of the second protective layer 50.

The method in accordance with the present invention mainly adds the ionized water cleaning step S3 between the first electroplating step S2 and the printing step S5, and the ion-protective coating 30 is formed on the surface of the first protective layer 20. The ion-protective coating 30 can increase the adhesion of the printing pattern 40 and the printing pattern 40 does not easily fall off.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A manufacturing method comprising steps of:
a first cleaning step, wherein a surface of a tool is cleaned by clear water to remove impurities;
a first electroplating step, wherein the surface of the tool is electroplated, and a first protective layer is formed on the surface of the tool;
an ionized water cleaning step, wherein ionized water is sprayed on the surface of the tool to thereby clean sulfide on the surface of the tool and ions in the ionized water are adhered to pores of the first protective layer to form an ion-protective coating;
a drying step, wherein the ionized water on the surface of the tool is dried so that the ion-protective coating is hardened;
a printing step, wherein a printing pattern is printed on the ion-protective coating;
a second cleaning step, wherein the printing pattern is cleaned by clear water to reduce acidity of the printing pattern, and stains around the printing pattern are cleaned; and
a second electroplating step, wherein the surface of the tool is electroplated at portions without the printing pattern thereon to form a second protective layer on the surface of the tool at portions without the printing pattern thereon.

2. The manufacturing method as claimed in claim 1 further comprising a cation removal step after the printing step, wherein the cation removal step comprises placing the tool into an electrolyte, then electrically connecting the tool to an anode, and electrically energizing the anode, metal cations on the surface of the tool and on the printing pattern are dissolved, the cations are attracted by anions in the electrolyte, and the metal cations on the surface of the tool and the printing pattern are moved into the electrolyte, whereby the cations on the surface of the tool and the printing pattern are removed.

3. The manufacturing method as claimed in claim 2 further comprising a third electroplating step after the second electroplating step to electroplate a third protective layer on an outer surface of the second protective layer.

4. The manufacturing method as claimed in claim 3, wherein in the first electroplating step, the surface of the tool is electroplated with a layer of nickel.

5. The manufacturing method as claimed in claim 4, wherein in the second electroplating step, the surface of the tool is electroplated with a layer of nickel.

6. The manufacturing method as claimed in claim 5, wherein in the third electroplating step, the surface of the tool is electroplated with a layer of chromium.

7. A hand tool comprising:
a body;
a first protective layer formed on a surface of the hand tool;
an ion-protective coating formed on a surface of the first protective layer;
a printing pattern attached on a surface of the ion-protective coating; and
a second protective layer electroplated on the ion-protective coating at portions without the printing pattern thereon.

8. The hand tool in claim 7, wherein the hand tool further comprises a third protective layer electroplated on a surface of the second protective layer.

9. The hand tool in claim 8, wherein the first protective layer is electroplated with a layer of nickel.

10. The hand tool in claim 9, wherein the second protective layer is electroplated with a layer of nickel, and the third protective layer is electroplated with a layer of chromium.
